(19) United States
(12) Patent Application Publication
(10) Pub. No.: US 2011/0075258 A1
(43) Pub. Date: Mar. 31, 2011

(54) LIGHT CONTROL FILMS AND METHOD THEREOF

(75) Inventor: Patrick W. Mullen, Menominee, CT (US)

(73) Assignee: REFLEXITE CORPORATION, Avon, CT (US)

(21) Appl. No.: 12/994,382

(22) PCT Filed: May 22, 2009
(86) PCT No.: PCT/US09/45037

§ 371 Date: Nov. 23, 2010

Related U.S. Application Data
(60) Provisional application No. 61/128,657, filed on May 23, 2008.

(51) Int. Cl. G02B 5/30; G02B 1/10; G02B 27/30; B01J 19/08; C08F 2/46

(52) U.S. Cl. 359/492.01; 359/641; 427/598; 427/457; 427/487

(57) ABSTRACT

A light control film including a polymer carrier film and a coating disposed on the carrier film and including dark colored or reflective particles dispersed within a cured resin matrix, the particles being aligned either perpendicular or parallel to a major surface of the carrier film, and method for making the same.

This application claims the benefit of U.S. Provisional Application No. 61/128,657 filed May 23, 2008, which is herein incorporated by reference in its entirety.

### FIELD OF THE INVENTION

The present invention relates to light control films and method thereof.

### BACKGROUND

In computer display applications, it is often desirable for the user to have exclusive viewing capability. Such privacy is required during the exchange of sensitive information, which occurs, for example, during the use of automatic teller machines (ATMs) or during examinations conducted in computer based testing centers. To ensure privacy, a view control film typically is applied to the computer screen. The film limits the position from where the display can be viewed.

Conventional control films employ louvers within the film, and are formed by skiving stacks of laminated cellulosic films. This process tends to be expensive, and the films are difficult to manufacture in large sheets. Additionally, louver films are only capable of blocking oblique light coming from one direction. Thus, it is still possible for persons other than the user to view the screen.

Also known are contrast enhancing films, however such films have a generally linear prismatic construction, and therefore exhibit the same limitations. Furthermore, contrast enhancing films are similarly expensive to produce.

A need therefore exists for a light control film that is capable of overcoming the above described issues and is capable of being produced in a continuous manufacturing operation.

### SUMMARY

The present invention is directed to light control films and continuous processes for making light control films, including collimating films capable of maximizing light transmission at an axis orthogonal to a major surface of the film, while blocking much of the light that enters the surface from other angles.

In one aspect, the invention relates to a continuous process for forming a light control film, including the steps of dispersing alignable particles in a clear curable resin to form a coating, applying the coating to a carrier film, aligning the particles in a field, and curing the coating.

In another aspect, the invention relates to a collimating film including a polymer carrier film and a coating disposed on the carrier film and including aligned reflective particles dispersed within a cured resin matrix, the particles being aligned perpendicular to a major surface of the carrier film.

In another aspect, the invention relates to a polarizing film, including a polymer carrier film and a coating disposed on the carrier film and including aligned reflective particles dispersed within a cured resin matrix, the particles being aligned parallel to a major surface of the carrier film.

The invention provides a light control film and a method for making a light control film that is composed of a clear, transmissive matrix polymer that is interspersed with reflective or dark colored particles that are aligned to the film surface.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an illustration of one embodiment for applying and curing a resin matrix containing alignable particles on a carrier film;

FIG. 2 is a cross sectional view of a collimating film of an embodiment of the invention; and

FIG. 3 is a cross sectional view of a polarizing film of an embodiment of the invention.

### DETAILED DESCRIPTION

The present invention relates to a light control film, such as a collimating film or a polarizing film containing aligned dark colored or reflective particles, and a continuous method for making the same.

In one embodiment, the light control film comprises a polymer carrier film and a coating disposed on the carrier film. The coating comprises aligned particles dispersed within a cured resin matrix. The finished light control film can function as a polarizing film or a collimating film, depending on the orientation of the aligned particles. In a collimating film, the particles are present in a concentration such that the film transmits substantially all of the light entering the film in a direction approximately perpendicular to a major surface of the carrier film, but absorbs or reflects light entering the film at other angles. In a polarizing film, the particles are present in a concentration such that the film transmits substantially all of the light entering the film in a direction approximately parallel to the major surface of the carrier film, but absorbs or reflects transmission of light entering the film from other directions.

The coating is formed by dispersing alignable dark colored or reflective particles within a solidifiable resin matrix. Preferably, the aligned particles are uniformly distributed throughout the matrix, although the particles can be distributed in other manners. One method of achieving a uniform coating mixture of the particles within the resin is to add glass balls and mill the coating mixture in a ball mill. The composition and viscosity of the mixture should be such that the particles can be aligned in the mixture by external electric or magnetic fields or flow fields during the formation of the solid or visco-elastic matrix.

When cured, the matrix material should be light transmissive and preferably flexible, although the matrix material can have other properties. Suitable matrix materials include ethylenically unsaturated resins that can be radiation cross-linked using various sources of actinic radiation. Also suitable are epoxy resins (such as Buehler Epo-Mix, No. 20-8133-001, Buehler Ltd., 41 Waukegan Road, Lake Bluff, Ill. 60044), and Bismaleimide resins (such as Ciba-Geigy Matridmid 5292, Ciba-Geigy, Plastics and Additives Division, 3 Skyline Drive, Hawthorne, N.Y. 10532). Thermoplastic resins are also potential matrix materials. An example of a potentially suitable thermoplastic is polyethylene (such as Epolene N-15, Eastman Chemical Products, Kingsport, Tenn. 37662).

The alignable particles to be dispersed within the matrix may exist in various shapes, for example, in the form of aciculae or flakes. As used herein, the terms “aciculae” and “acicula” refer to particles (or collections of smaller particles) that have a generally needle-like shape. The length of typical aciculae is between about 3 and about 500 nanometers, although the aciculae can have other dimensions. Examples of suitable aciculae are disclosed in U.S. Pat. No. 5,030,371, incorporated herein by reference. As used herein, the term “flake” refers to particles (or collections of smaller particles) that have a generally planar shape. Examples of suitable flakes are disclosed in U.S. Pat. No. 7,042,617, incorporated herein by reference.

The alignable particles can be magnetic and/or or electrically conductive, so as to be alignable by a magnetic and/or electric field. Suitable magnetically alignable particles include, but are not limited to ferroelectric materials; ferromagnetic materials, such as iron, cobalt, and chromium (IV) dioxide; ferrimagnetic materials, such as gamma iron oxide, magnetite, and barium ferrite; paramagnetic materials; ferrofluidic materials; and the like. Suitable electrically alignable particles include, but are not limited to liquid crystal flakes and other electrically conductive materials.

In one embodiment, the alignable particles have a surface that is light reflective or enhanced with a light reflective coating. Reflectivity of the alignable particles can be achieved, for example, by various coating methods, such as chemical vapor deposition, physical vapor deposition, electrolytic deposition, and electroless deposition.

In another embodiment, the alignable particles have a surface that is dark colored, preferably black.

Suitable carrier films can be formed from a material that is thermoplastic, transparent, and flexible, such as polyethylene terepthalate (PET), polyester, polycarbonate, polyurethane, acrylic, and polyvinyl chloride (PVC) by way of example.

In other embodiments, a supplemental film is be added, although other numbers and types of layers could be added. For example, a supplemental film can be used so that the resin is sandwiched between the carrier film and the supplemental film. A supplemental film can be used, for example, as a mask for forming a pattern on the laminate, or as an adhesive.

To ensure proper adhesion between the coating and the carrier film, a primer can be optionally employed.

A field is applied to the mixture in the mold, such that the flux lines are oriented in a desired position. The field strength must be sufficiently strong to cause an alignment of the particles. Oscillating fields can also be used to orient the particles, although other types of fields can be applied in other manners. Oscillating fields can orient the particles in their dispersed positions without attracting the particles toward one surface, or the other, within the resin. The frequency of the oscillation can be varied during the curing process. In one embodiment, an electromagnet is used to provide a magnetic field, which aligns the particles within the resin. The particles tend to align such that the longitudinal axes of the particles are essentially parallel to the flux lines of the magnetic field. After the particles are aligned, the magnetic field is maintained until the viscosity of the resin increases (as a result of polymerization) to a viscosity sufficient to lock or hold the particles in aligned positions.

Electric fields can be applied by devices such as electromagnets, antennas, waveguides or by other methods.

Curing methods include use of solvent drying, or by exposure to actinic radiation, such as ultraviolet light, X-rays, gamma rays, and high energy electron beams. Duration and intensity of exposure to curing treatment depends upon the materials and dimensions of the laminate being treated.

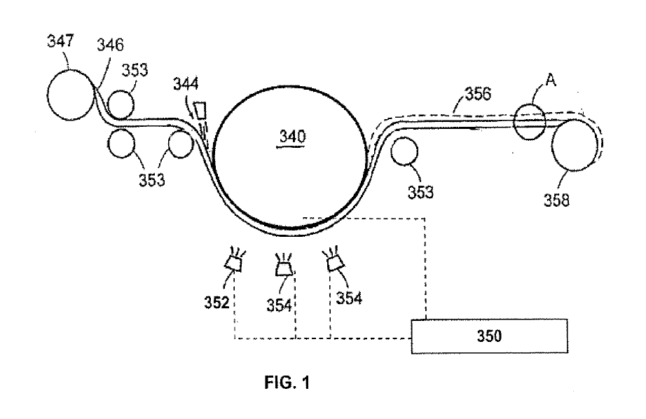

An exemplary method of laminating a light control film is illustrated in FIG. 1. A curable resin 344, such as an ultraviolet-curable resin, containing the dispersed but not yet aligned particles can be flowed between the casting drum 340 and a carrier film 346, dispensed from a roll 347. The curable resin is then exposed to a magnetic or electric field by way of field source 352 to cause alignment of the particles. The resin 344 is laminated to the carrier film 347 and cured as the two are passed along the casting drum 340 and exposed to a curing treatment, such as UV lamps 354, or by use of solvent drying. The laminated film coated with cured resin 356 (containing aligned particles) is rolled onto take-up roller 358. Various components within the process are controlled by controller 350.

Referring more specifically to FIG. 1, a predetermined thickness of resin coating 356 can be provided on carrier film 346. In one embodiment, this is accomplished by a fixed gap provided between the carrier film 346 and casting drum 340. In other embodiments, the running speed of the carrier film 346 and viscosity of the resin 344 can be used to control the thickness of the resin coating 356, although other manners for controlling the thickness can be used. The thickness of the cured coating 356 must be greater than the length of the particles as aligned across the thickness of the coating. This ensures that the resin matrix fully envelopes the particles (i.e., no particles protrude outside the resin matrix). Optionally, the casting drum 340 can include tooling on its outer surface to create a pattern or impression in the resin material.

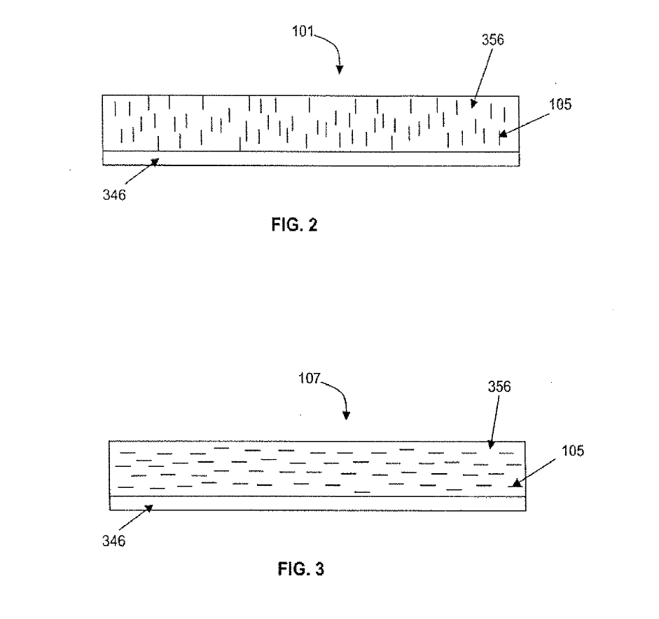

Referring to FIG. 2, a cross section of a collimating film 101 including cured resin coating 356 containing aligned acicular particles 105 is illustrated. Acicular particles 105 are aligned so as to transmit light approximately perpendicular to a major surface of the carrier film 356.

Referring to FIG. 3, a cross section of a polarizing film 107 is illustrated. In the polarizing film 107, acicular particles 105 are aligned within cured resin coating 356 so as to allow transmission of light that is approximately parallel to a major surface of the carrier film 346.

While this invention has been particularly shown and described with references to example embodiments thereof, it will be understood by those skilled in the art that various changes in form and details may be made therein without departing from the scope of the invention encompassed by the appended claims.

What is claimed is:

1. A method for forming a light control film, the method:
dispersing alignable particles in a clear curable resin to form a coating;
applying the coating to a carrier film;
aligning the particles in a field; and
at least one of curing and drying the coating, wherein the dispersing, the applying, the aligning, the at least one of curing and drying occur continuously.

2. The method of claim 1 wherein the particles are aligned by a magnetic field.

3. The method of claim 3 wherein the magnetic filed is oscillating.

4. The method of claim 1 wherein the particles are aligned by an electric field.

5. The method of claim 4 wherein the electric filed is oscillating.

6. The method of claim 1 wherein the particles have a dark colored surface.

7. The method of claim 6 wherein the dark colored surface is black.

8. The method of claim 1 wherein the particles have a reflective surface.

9. The method of claim 1 wherein the alignable particles are aciculae.

10. The method of claim 1 wherein the alignable particles are flakes.

11. The method of claim 1 wherein the coating is cured by exposure to actinic radiation.

12. The method of claim 1 wherein the coating is cured by solvent drying.

13. The method of claim 1 wherein the coating is a thermoplastic.

14. The method of claim 1 wherein the particles are aligned perpendicular to a major surface of the carrier film.

15. The method of claim 1 wherein the particles are aligned parallel to a major surface of the carrier film.

16. The method of claim 1 wherein the particles are aligned between parallel and perpendicular to a major surface of the carrier film.

17. A collimating film comprising:
a polymer carrier film; and
a coating disposed on the carrier film and comprising aligned reflective particles dispersed within a cured resin matrix the aligned reflective particles being aligned perpendicular to a major surface of the carrier film.

18. The film of claim 17 wherein the aligned reflective particles are aciculae.

19. The film of claim 17 wherein the aligned reflective particles are flakes.

20. The film of claim 17 wherein the aligned reflective particles are formed of a magnetic material.

21. The film of claim 17 wherein the aligned reflective particles are formed of an electrically conductive material.

20. The film of claim 17 wherein the coating is sandwiched between a carrier film and a supplemental film.

21. The film of claim 17 wherein the aligned reflective particles comprise chromium dioxide.

22. The film of claim 17 wherein the carrier film is a polyethylene terepthalate (PET) film.

23. A polarizing film comprising:
a polymer carrier film; and
a coating disposed on the carrier film and comprising aligned reflective particles dispersed within a cured resin matrix, the aligned reflective particles being aligned parallel to a major surface of the carrier film.
